(19) United States
(12) Patent Application Publication
(10) Pub. No.: US 2014/0006053 A1
(43) Pub. Date: Jan. 2, 2014

(54) INDIVIDUALIZED HEALTH PRODUCT IDENTIFICATION AND MANAGEMENT SYSTEM

(71) Applicant: Netclinic, Inc., Plymouth, MN (US)

(72) Inventors: David MOEN, Mahtomedi, MN (US); Peter MOEN, Plymouth, MN (US)

(21) Appl. No.: 13/722,183

(22) Filed: Dec. 20, 2012

Related U.S. Application Data
(60) Provisional application No. 61/581,250, filed on Dec. 29, 2011.

(51) Int. Cl. G06F 19/00

(52) U.S. Cl. CPC G06F 19/322
USPC 705/3

(57) ABSTRACT

A computerized method for administration of a health care system, comprising, providing a central computer system having remote access capability to one or more participants via a remote computer link, assessing the participants health care needs through one or more query instructions utilizing said central computer system to collect the participants health care information, and aggregating the health care information into a unique participant ID.

### CROSS REFERENCE TO RELATED APPLICATION

The present application incorporates herein by reference U.S. patent application Ser. No. 13/088,004 filed on Apr. 15, 2011, U.S. patent application Ser. No. 12/072,570 filed Feb. 27, 2008, and U.S. Patent Application No. 60/903,652, filed Feb. 27, 2007.

The present application claims priority to, and incorporates by reference, U.S. Patent Application No. 61/581,250 filed on Dec. 29, 2011.

### FIELD OF THE INVENTION

The present invention relates generally to health care delivery, care management, and payment administration systems providing methodology and technical infrastructure to facilitate consumer/payor/provider integration to simplify care delivery and payment. More particularly, the present invention relates to a secure, computer-based health care delivery, telecommunication, and product administration system for individualized detection and treatment of medical conditions while providing tools for enhancing compliance and monitoring of such conditions. A unique identification code (NetCliniclD “NCID”) and supporting technical infrastructure transform the healthcare experience allowing real time management of healthcare service supply and demand while integrating health plan benefits design and payments, individualized treatment plans, provider network configurations critical to simplifying the consumer/provider experience while enhancing patient - provider connectivity, behavior change strategies, and management of clinical variation critical to improving outcomes and reducing cost.

### BACKGROUND OF THE INVENTION

Fifty years ago, the primary method of initial patient contact with the medical health care system was the house call. Medical clinics eventually evolved to regionalize medical care around clinics as a way to reduce the transaction costs associated with the house call, thus improving workflow efficiency and maximizing the doctor's available work schedule. While accomplishing the objective of enabling doctors to see more patients in a day, the workflow of the modern clinic-based system has become a fragmented, complicated, costly, and sometimes ineffective method for activating individuals to seek appropriate preventive health care and improve disease outcomes across the populace.

Meanwhile, advances in medicine have increased the ability to predict, diagnose, and treat serious illnesses. Significant investment on the part of medical equipment, pharmaceutical and biomedical companies has enabled the health care industry to better identify illnesses at early stages and treatments for individuals. The amount of treatment, equipment, medicine, surgical procedures, and other health care assets has increased significantly and continues to expand. The predictive, diagnostic, and corrective capabilities of the modern health care industry have greatly increased the ability to improve individual health outcomes but the increasing options for treatment have introduced new complexities and with it increasing clinical variation and escalating cost in the overall system necessary to manage this complexity.

Over the last few decades doctors have become vendors to insurance companies that package and sell products to the market. As health plan products evolved to meet increasing supply of and demand for services the complexity of the health care provider and patient payment transaction has increased exponentially. Providers now spend 15-20% of their resources simply getting paid. Clinical navigation has become incredibly difficult for those needing various combinations of expertise and treatment to manage chronic disease or acute conditions. Patients with chronic disease consume 75% of today's medical spend.

Lack of system adaptation to increasing complexity has resulted in tremendous inefficiency, fragmentation, and frustration on the part of doctors and their patients while adding huge cost and disrupting the overall health care experience. Smart daughters or personal health navigators are today's adaptation to clinical complexity. Outside help is often needed for many to simply understand the financial aspects of these transactions.

In sum, delivery of health care services is not supported with an appropriate identification methodology and product distribution infrastructure. This invention integrates key components of the system needed to simplify the consumer and provider experience while supporting care delivery and payment system transformation. This invention absorbs system complexity thus simplifying the patient/provider experience. It provides virtual integration proactively and more predictably aligns condition-specific interventions and reliable service networks to ease navigation while providing outcomes that are more predictable. The system enables a unified network communication infrastructure that simplifies management of supply, distribution, and variability of health care services on a real time basis. Taken together, this system empowers consumers with tools to efficiently navigate purchasing and access to care delivery products and services while transforming the health care purchasing and delivery experience. It also supports the sanctity of the individualized patient/provider interaction.

This invention is timely and critical as health insurance exchanges and the employer trend to defined contribution benefits plans will place more decisions in the consumer's hands. The transformative integration enabled by this system will support efficient navigation, improved clinical outcomes, and reduced costs necessary to help us create a sustainable health care system.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows the matrix coding system.

FIG. 2 shows the encoding information.

FIGS. 3-8 show the NCID identifiers

FIG. 9 shows the NCID configuration and assignment process.

FIG. 10 shows Consumer Access and Network Configuration System.

FIG. 11 shows the NCID being used at the Care Delivery Interface.

FIG. 12 shows an application login page.

FIG. 13 shows the application home page.

FIG. 14 shows a Manage Your Health page of the application.

FIG. 15 shows a My Profile demographic page of the application.

FIG. 16 shows a My Profile personal health history page of the application.

FIG. 17 shows a My Profile health habits page of the application.

FIG. 18 shows a My Profile family history page of the application.

FIG. 19 shows a Learning Communities selection page of the application.

FIG. 20 shows a Learning Communities page of the application.

FIG. 21 shows a Toolkit page of the application.

FIG. 22 shows a Virtual Care page of the application.

FIG. 23 shows a Choose Symptoms/Behaviors page of the application.

FIG. 24 shows a Change Monitoring Log page of the application.

FIG. 25 shows a Create Learning Community page of the application.

FIG. 26 shows a My NetClinic page of the application.

FIG. 27 shows a summary of features of the present invention.

### SUMMARY OF THE INVENTION

One object of some embodiments of the invention is to provide an improved apparatus and method for collecting health care information, delivering health care, and activating patient compliance therewith.

In accordance with a preferred embodiment of the invention, there is disclosed a computerized method for administration of a health care system, comprising, providing a central computer system having remote access capability to one or more participants via a remote computer link, assessing the participants health care needs through one or more query instructions utilizing said central computer system to collect the participants health care information, and aggregating the health care information into a unique participant ID.

### DETAILED DESCRIPTION OF THE PREFERRED EMBODIMENTS

In the Figures is shown an application that provides virtual consumer/payor/provider integration. In the preferred embodiment, the application is a software implementation configured to operate on one or more general or specific purpose computing devices that can be deployed across one or more interconnected computer information and telecommunication networks. As such, application can be used remotely by one or more users, or services providers, either physically located at the same site or different sites. Configuration of the system can also be managed by administrators of the system components that inter-relate to serve patients at the right time with the right service.

An important aspect of this invention is the NetCliniclD (NCID). NCID is a code that contains four categories of information: health; demographic; health plan product; and provider network configuration information specific to each individual. The matrix coding system allows the foregoing system elements to be individualized and characterized and assigned to the NCID. The personal identification code enables the supporting system to simplify access to the right care at the right time at the right price at the point of service. The solution substantially eliminates the tremendous confusion and complexity that characterizes prior art interactions, but still supports informed decision making.

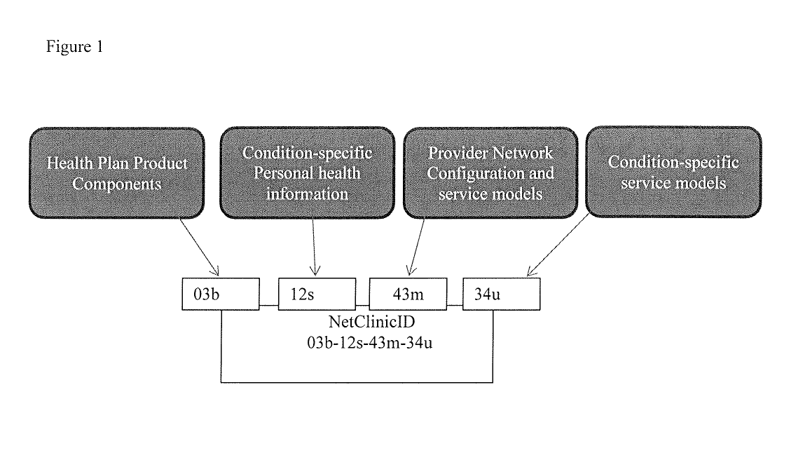

The components of the delivery and payment systems that require integration include health plan benefit design and pricing, provider network configuration and access, and care solution service model access, configuration, and pricing. The NCID scoring system provides the most efficient way to individualize and characterize these components supporting the integrated point-of-service experience consumers and providers desire. FIG. 1 illustrates an implementation of the matrix coding system which integrates the four categories of information to create the NetClinic ID, wherein each information category contributes an element to the NCID.

One object of some embodiments of the invention is to provide an improved apparatus and method for collecting health care information, purchasing health care products, delivering health care, managing clinical variation, and activating patient compliance therewith. Leverage points enabled by the NCID scoring system and supporting apparatus that will improve outcomes and reduce cost include, virtual payor/provider integration, and individualized care plans with targeted patient education tailored to standardize patient expectations, patient experience, and reduce risk of variation. Leverage is also created through a unified network communication and management apparatus which enables network management strategies to reduce clinical variation while supporting supply/demand management to ensure timely access to a customized network of services. Taken together, all these leverage points afford a transformative health care experience at reduced cost.

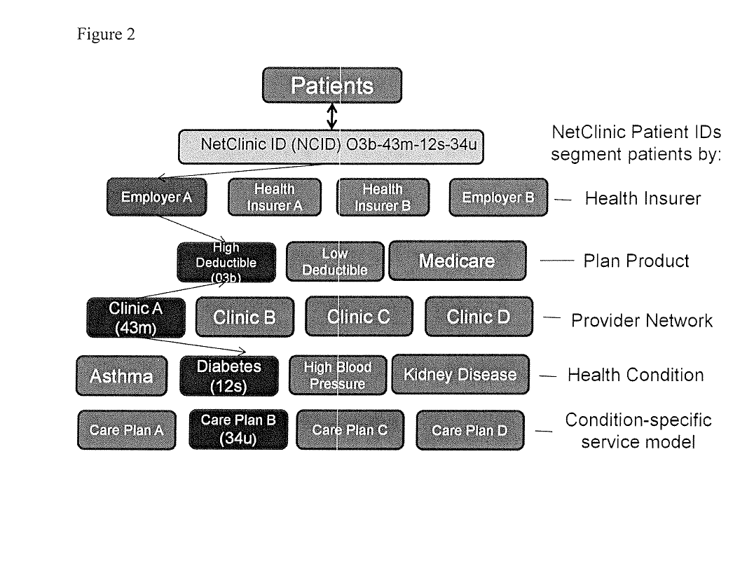

FIG. 2 demonstrates the process of encoding information from the defined categories into a single NCID, which defines an individualized and particularized fingerprint for use in health care treatment and payment.

The process is further broken down into each component steps of the encoding process in the series of tables below.

Thus, the present invention would create a user/patient ID that immediately identifies the patient, the health care plan, the patient's preferred clinic, and the patient's specific health care condition (or conditions). All of this information is encoded in the NCID through the scoring system.

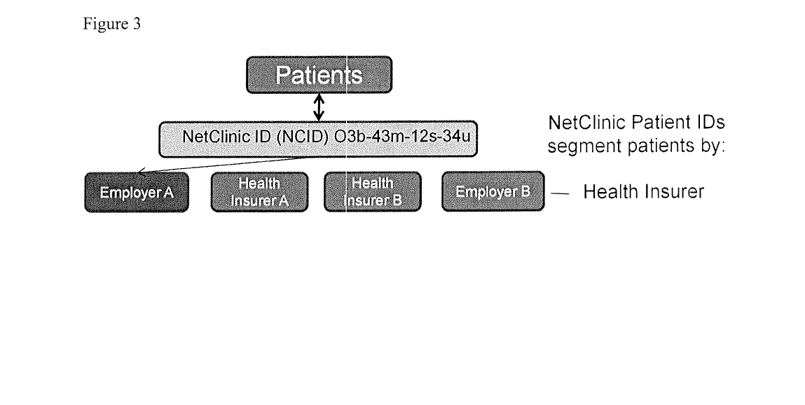

To further illustrate the NCID of the present invention, the following segmentation models shown in FIGS. 3-8 demonstrate how the NCID captures information from different segments of the application of the present invention.

In this case shown in FIG. 3, the NCID identifies the user/patient, and the insurance provider (which can be an insurance company or a corporation that either is self-insured or provided coverage through an outside provider). The first three characters in the NCID are therefore used to identify the insurer.

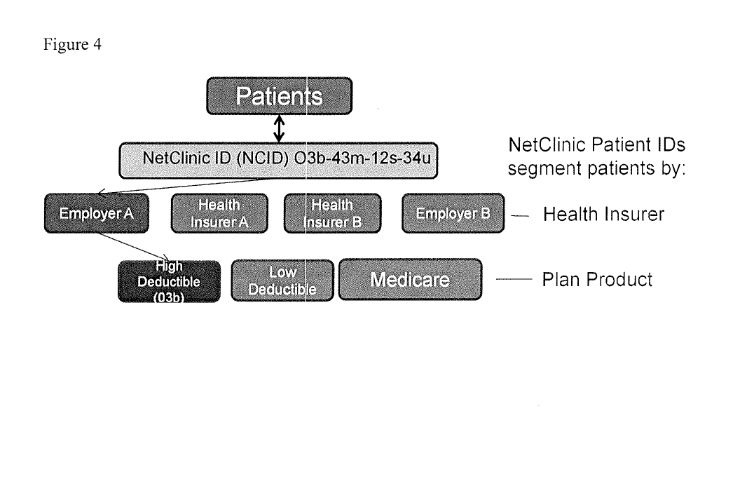

As shown in FIG. 4, the NCID also codes for the specific information about the patient/user health care insurance plan. The first three characters in the NCID are therefore used to identify the insurer and the insurance product plan.

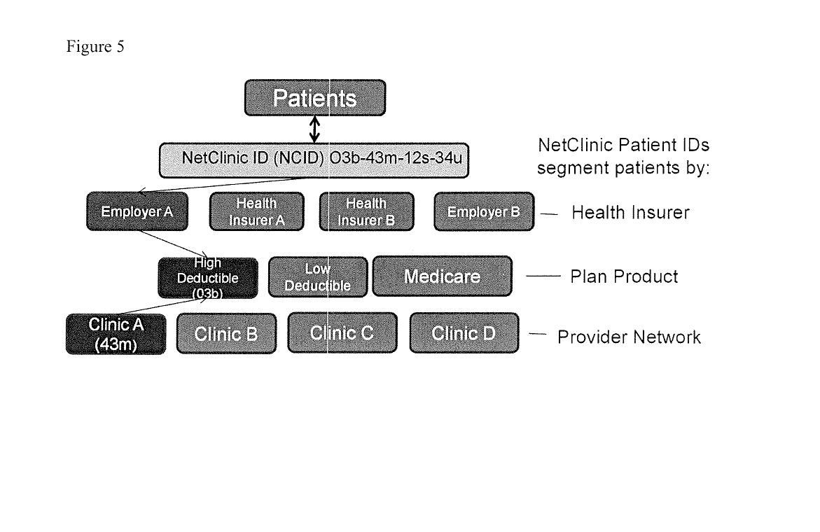

As shown in FIG. 5, the NCID further codes a health care professional provider group used or preferred by the user/patient and embeds contracted pricing. For example, the group may be identified by a clinic location (as above) with contract pricing specific to that group. The second three character grouping in the NCID is used to identify the provider network/healthcare professional group.

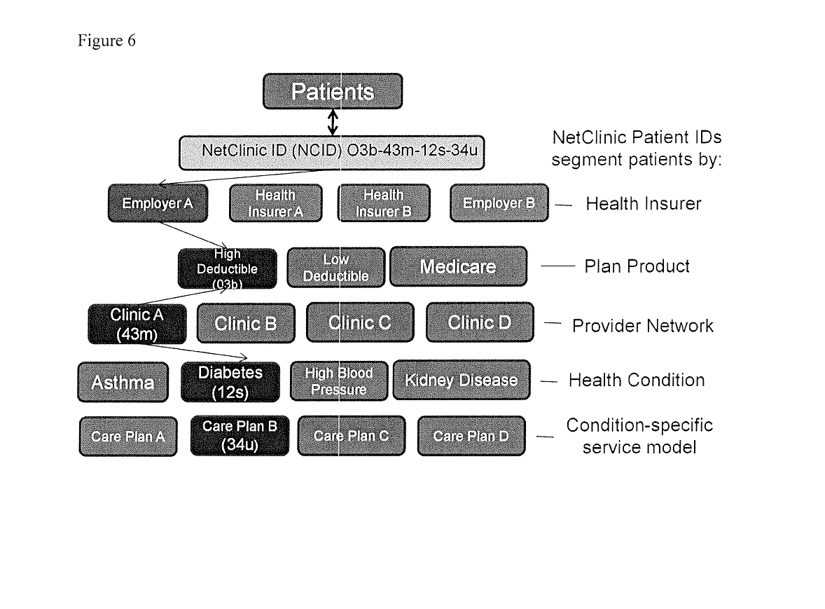

As shown in FIG. 6, the NCID also codes for particular health conditions, as well as condition-specific pathways based on the heath condition which is provided by the coded provider group and may contain a specific bundled price for that service. The third three character grouping in the NCID is used to identify the condition-specific information, and the fourth identifies the condition-specific care model.

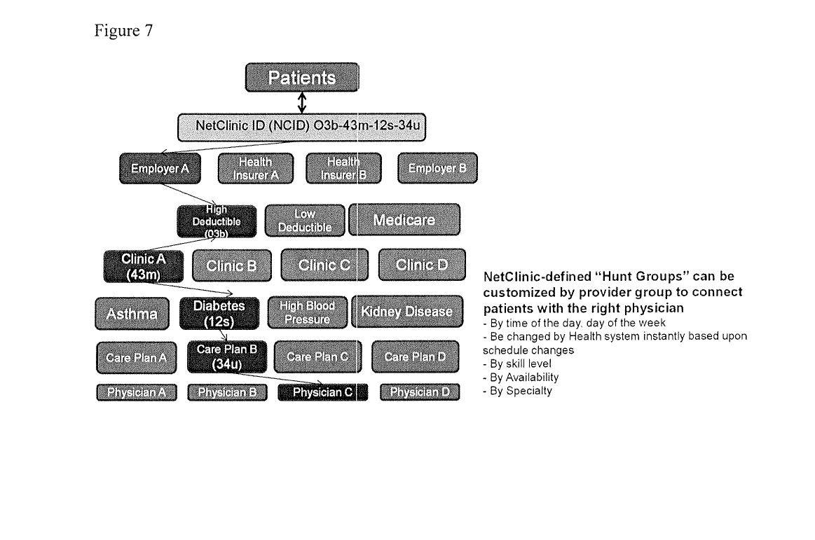

Further subdivision and specialization is also possible within the scheme of the present invention. As shown in FIG. 7, coding can be done by so-called “hunt groups” that allow the NCID to associate a patient with a health care provider by time of day/week, skill level, availability, or specialty. These attributes can be modified in real-time based on changes to schedule or other similar factors.

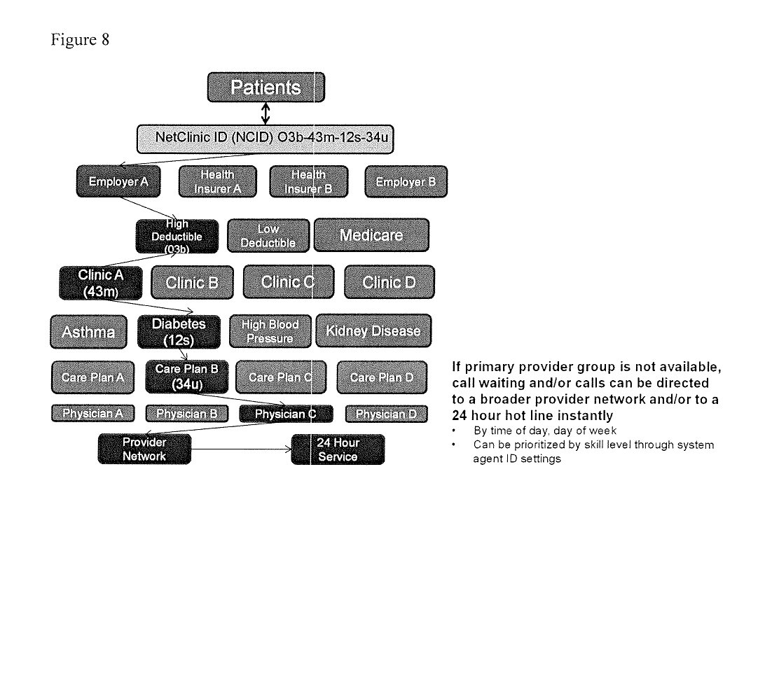

As shown in FIG. 8, the NCID also codes for alternative referrals should the primary provider be unavailable for any reason allowing proactive management of access to service.

The present invention, thusly enabled, can have a substantial impact on reducing clinical variation. Clinical variation accounts for more than 30% of all health care spending according to health plan research. NCID and the supporting apparatus enabled by this invention allow proactive, discrete, and real-time management of clinical variation. Clinical variation is caused by variable judgment in clinical decision-making, variable procedural skill resulting in differing outcomes and complication rates, and variable application of the right care to the right patient at the right time. In this case, the NCID further defines even more specific provider groups, and can group users/patients based on other aspects or providers such as skill level or other variables of performance (such as the Cost Based Index produced by the Episode Treatment Grouper (or category/group of practitioners)) and call coverage options allowing point-of-service management of supply and demand at a broader system level.

Examples in variable clinical judgment include decisions to admit patients to hospitals or manage them as outpatients. Experience demonstrates different admission rates (higher admissions correlate with high costs) with no change in outcomes across groups of providers. Examples in variable procedural skill results in different morbidity or mortality associated with like procedures done by different doctors. Applying interventions earlier and more effectively include examples such as effective outpatient wound care that lessens need for hospitalizations and surgery.

The NCID provides for a standard predefined provider for each condition based upon predefined criteria such as the performance of the providers, as determined by evidence-based medical intervention guidelines and cost information. The result ensures that the correct clinical judgments are made with regard to providing the right care at the right time to the right patients. Application of the NCID and supporting apparatus will help eliminate as much clinical variation as possible, further improving health outcomes, and lowering health care delivery cost.

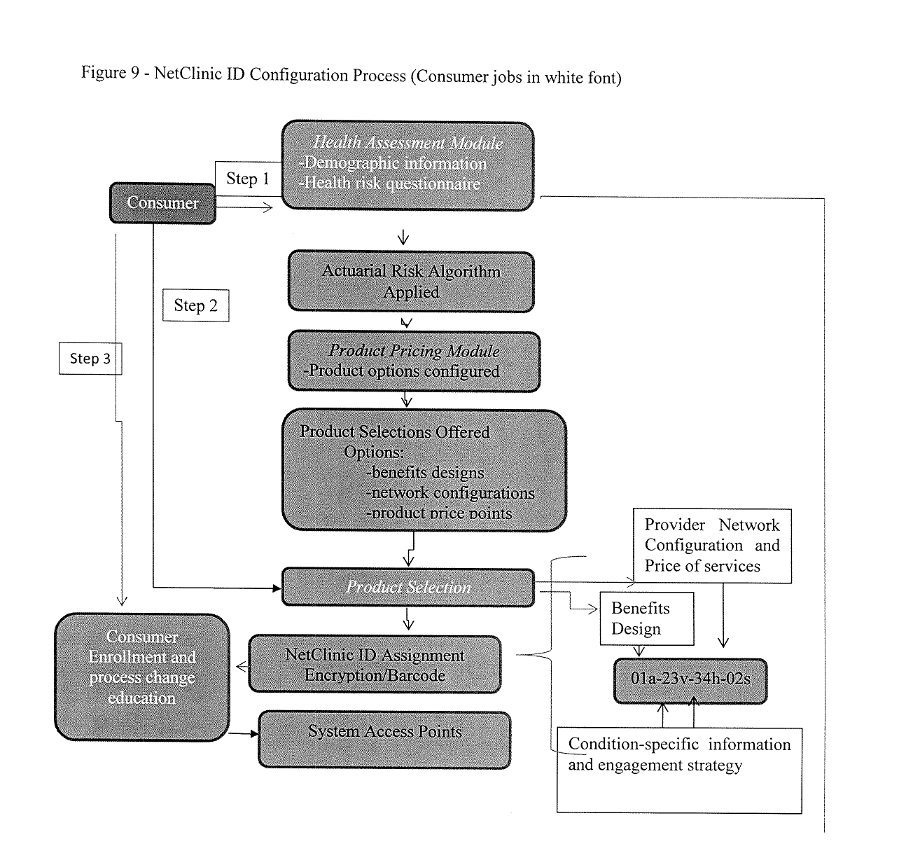

FIG. 9 depicts the process used to create the NetClinic ID based on a product configuration, which serves as the integrated network of supporting services needed to deliver the healthcare services required. This identification methodology and administrative process absorbs system complexity related to health plan products, benefits design, health assessment, care management, and provider network configurations creating a reliable and seamless experience at the care interface. The Consumer enrollment experience includes education about use of the NetClinic ID as the gateway to efficient and high quality health care services already integrated with supporting payment models.

The process involves both user specific steps and system specific steps. Step 1 comprises the user filling out an assessment (described in greater detail below) where the user provides certain information including demographic information and health risk information.

The system then applies standard industry algorithms and benefit design configurations which allow pricing of various product choices at different price points depending on consumer-selected requirements. When a consumer selects a health plan product, in step 2, that meets their need a unique participant NCID is created which integrates components of the system allowing for a seamless experience at the point of care interface.

In step 3 the user actually establishes an account on the system, wherein the user is associated with the system generated NCID. In some cases, the user receives education on the use of the system and is then ready to access and use the system as described herein.

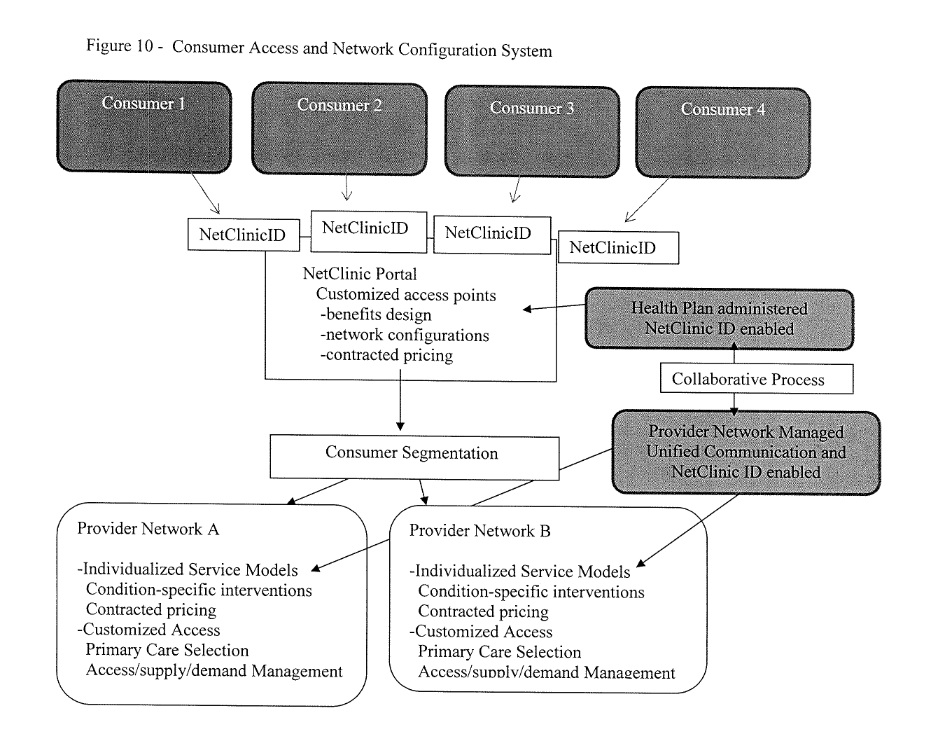

FIG. 10 depicts the unified communication network which organizes the supply of care delivery services needed to meet healthcare service delivery specifications and pricing requirements, across multiple users, providers, and health plans. The unified telecommunications network allows for real time management of supply (of healthcare resources) to meet ever-changing demands inherent in serving health needs of a population.

As shown in FIG. 10, providers participating in the network are configured in a unified communication system. This system allows real-time management of communication across the network facilitating service distribution, collaboration of component parts of the system needed to serve patients, management of supply and demand, and ongoing virtual configuration of component parts of the network.

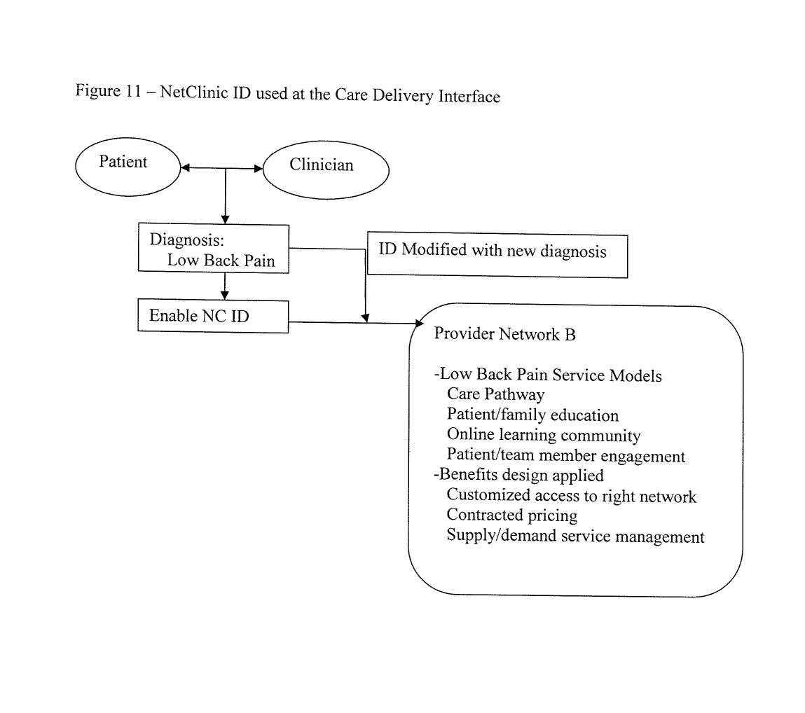

FIG. 11 depicts the NetClinic ID being used at a primary care physician's office who is contracted to participate in Provider Network B, to car for a patient with back pain that requires a referral for further treatment. In this case, the patient wants to be referred to an orthopedic surgeon and they desire a MRI scan. The physician knows that the right next step based upon historical clinical evidence, is to refer the patient to a chiropractor or physical therapist for manipulation and strengthening. Changing patient expectations is a challenge when people have a need and perceive a treatment path not supported by current clinical evidence. This dynamic promotes expensive and unnecessary utilization and cost in today's system. The NetClinic system provides condition-specific social media connections through mobile smart phone and computer devices to more effectively engage the patient in understanding the optimal path toward proper back health (in patient's stories and educational content) thus supporting reduction in unnecessary health service utilization through a new mechanism standardizing patient expectations.

At the care delivery interface this system and methodology empower the patient and clinician to reduce the complexity of their clinical interaction and supporting financial transaction using the components of the system. The system supports ongoing interactions needed to manage a person's health with optimized service combinations. The NetCliniclD adapts, changes, and is updated in response to changes in a consumer or patient's health needs.

In prior art system, the physician spends time talking the patient out of the orthopedic referral (which can be difficult and time-consuming) or sends them to the orthopedist which puts them on a trajectory of higher cost and poorer long-term outcome. Under the healthcare delivery process without this invention, at the care delivery interface, patient and provider often do not know who is in a patient's pre-determined network. Often these referrals end up going to out-of-network providers which results in a myriad of activity that causes frustration and increases cost. FIG. 11 shows how with this invention, the patient and physician are now empowered with tools to align services according to pre-determined, condition-specific pathways designed to engage the patient in understanding their care, optimizing the care delivery process within provider networks that execute in a reliable way to produce predictable health outcome and lower healthcare costs. The invention also allows price transparency at the consumer level.

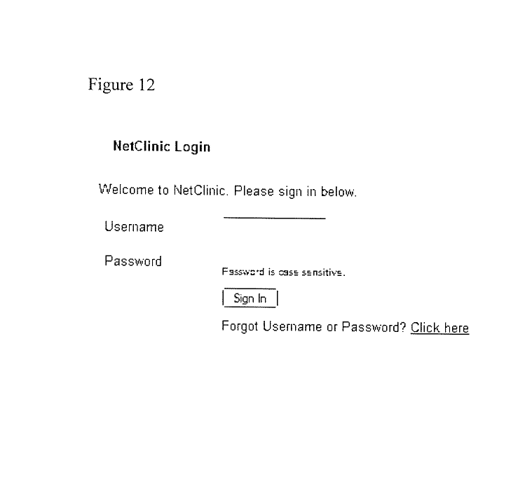

FIGS. 12-23 show consumer facing web-pages and applications that support easy use of the system.

FIG. 12 shows the application login screen, where the user would enter their user name and password, this generally would not include the NCID.

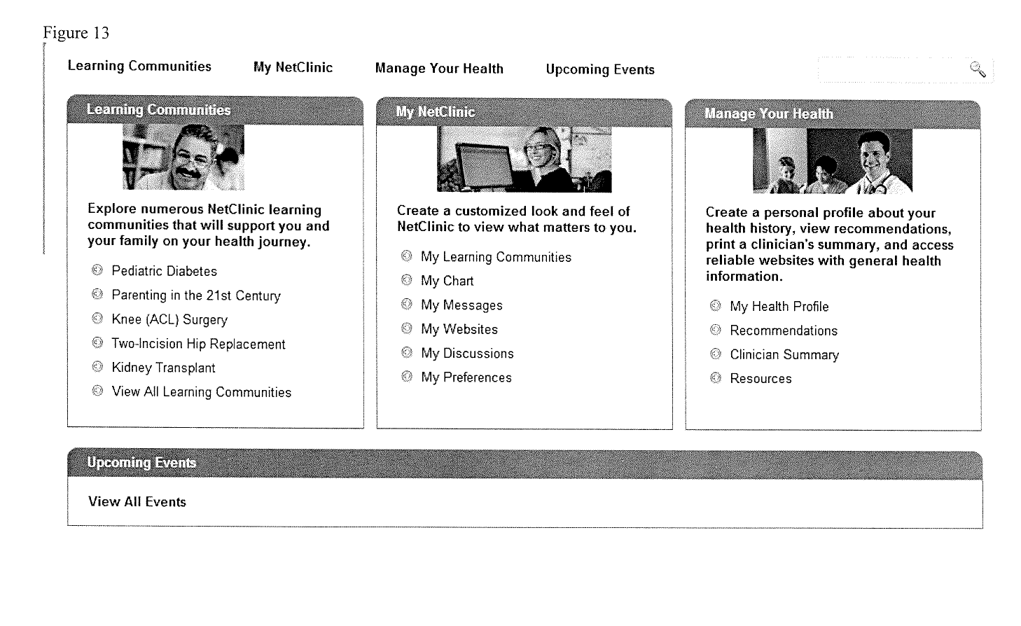

FIG. 13 depicts the home screen of the application, which a user can reach after successfully entering in their username and password. The creation of a username and password combine to identify a user to the application, which as described in greater detail herein below serves as a central point or focus for aggregation and interrelation of the particular users unique information, data, and records. The centralization or coordination of user information, data, and records provides one of the means to accomplish the goals of the present invention.

FIG. 13 shows that the application home page is divided into three distinct area of access and information collection/coordination, namely, Learning Communities, My NetClinic, and Manage Your Health. Each area is specifically tailored to the user in response to the information input into the application by or about the user. Each area further comprises a series of menu options listed generally toward the bottom of the large area icon. The areas, and/or area menu options can be activated by selecting either the menu item, selecting the area heading in the large icon, or through the drop down menus located above the large area icons.

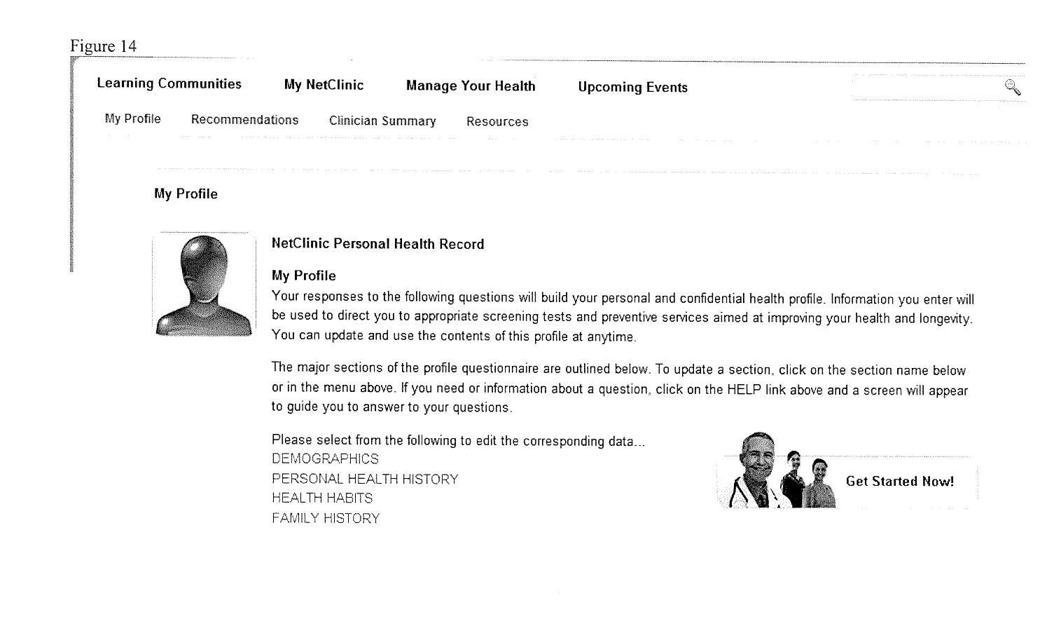

FIG. 14 shows the My Profile page, which is accessed from the Manage Your Health area or drop down menu. This screen begins the process of collecting personal health information used by the application to focus and tailor services on an individualized basis. The information is collected through a series of interactive data areas divided as follows: demographics, personal health history, health habits, and family history. The information collection process is initiated either by selecting the areas sequentially, or by selecting the “Get Started Now” icon.

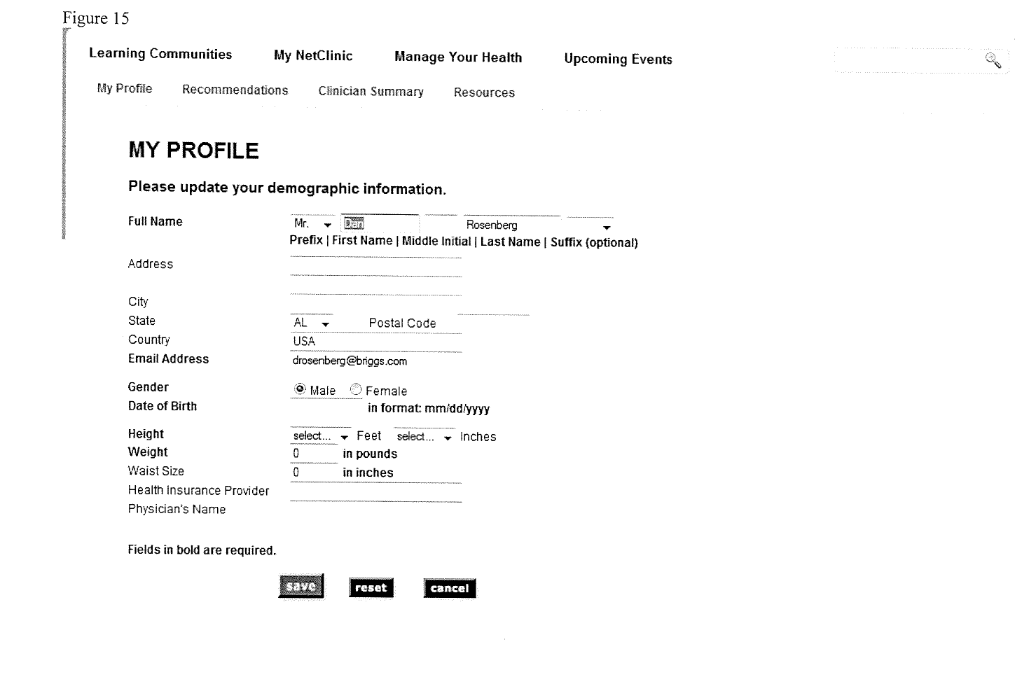

FIG. 15 shows the demographics page of the My Health Profile page. This page prompts the user to enter basic demographic information such as, name, address, gender, height, weight, and the like. Certain information is required and other information is optional, as noted in FIG. 15.

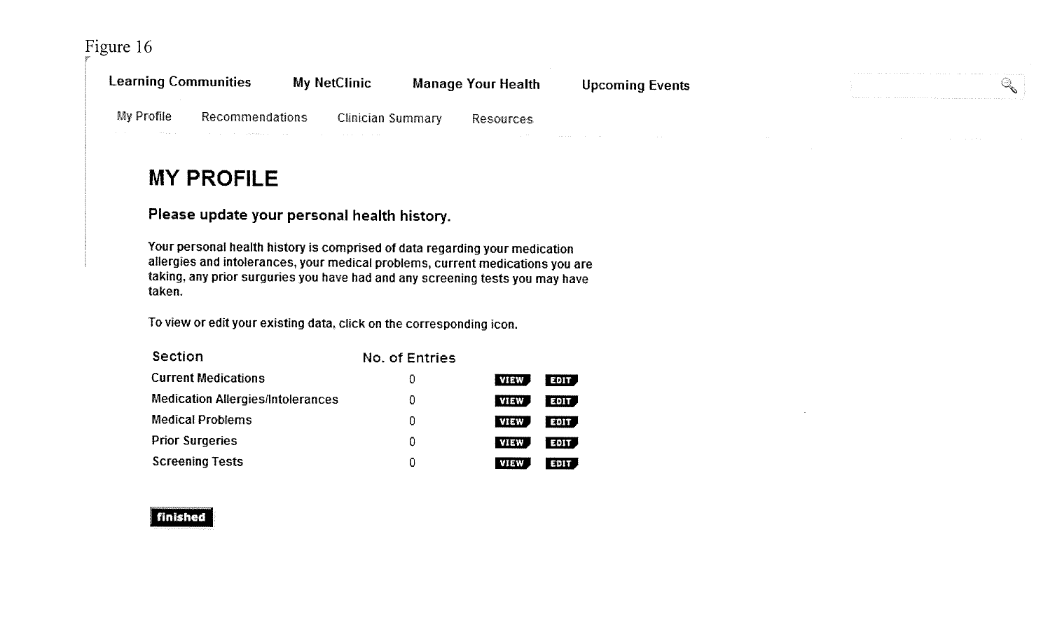

FIG. 16 shows the personal health history page of the My Health Profile page. This page prompts the user to enter information by providing a section relating to the user's history with medications, allergies, intolerances, medical problems or conditions, prior surgeries, screening/baseline medical tests, and the like. Each section can be viewed, which allows the user to review the current information in the application relating to the particular section, or edited. Editing allows the user to enter or change information in each section.

Selecting the edit function provides the user with a drop down menu list of items to select that are relevant to each section. For instance, selecting edit for the screening test section will display a list of possible screen tests, such as, blood pressure, cholesterol (total, LDL, HDL), triglycerides, mammogram, PAP smear, clinical breach exam, stool test for blood, flexible sigmoidoscopy, colonoscopy, prostate specific antigen, and the like. Selecting a particular item prompts the user to enter the item specific information, or takes the user through a query relating thereto. For purpose of further illustration, selecting the medical problems edit function will display a list of medical conditions to select from, such as, high blood pressure, diabetes mellitus, asthma, cancer, stroke, intestinal disturbance, depression, high cholesterol, heart disease, and the like. The user selects those conditions that apply and then provides any additional information relating thereto. The other sections of the personal health history page operate in a similar manner.

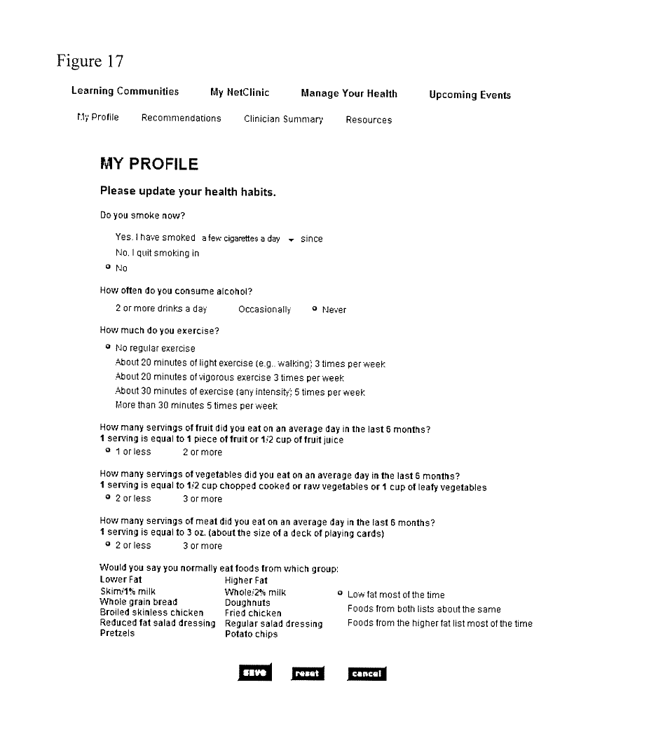

FIG. 17 shows the health habits page of the My Health Profile page. This page prompts the user for information relating to such things as smoking habits, diet, alcohol consumption, exercise, food preference, and other habits that have an impact on overall health.

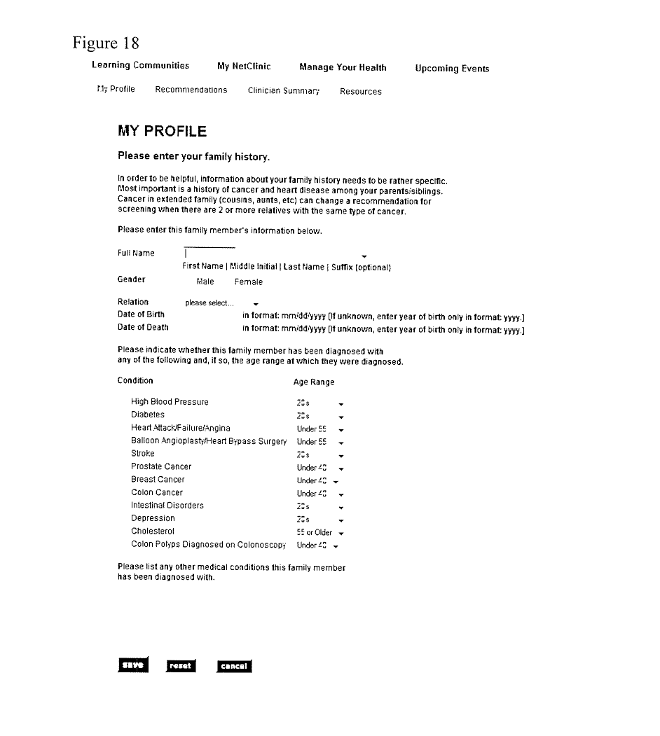

FIG. 18 shows the family history page of the My Health Profile page. This page allows the user to enter important information about family members that may be indicative of, and relevant to, the health of the user. For example, the page asks the user to indentify the family member and the relationship to the user and then provide responses information relating to various health conditions and dates of diagnosis. The user can enter additional textual information. Information for multiple family members can be entered and stored for use by the application.

Another feature of the Manage Your Health area is the recommendations tab. This feature takes the information entered into the system and in particular the information in the My Health Profile and creates a series of tailored recommendations for the user. The recommendations are also based on best practice standards, and other clinical and professional guidelines and principals. The recommendations are both reactive and proactive, in that they attempt to treat the user's current conditions, but also put into place screening tests, lifestyle recommendations for things such as diet, exercise, and alcohol and tobacco consumption in order to avoid likely or possible future conditions or complications. Giving the user a series of concrete steps and milestones to follow, coming from the user's health care professionals, is believed to be the best method of inducing activation (or compliance). Users, generally, are more likely to follow the advice of their health care professionals than they are to follow the advice of others involved, such as for example an insurance provider, employer, or the like.

An additional feature of the Manage Your Health area is the resources feature. This allows the user to access a wide array of resources of information that might be of interest to the user based on the user's particular circumstances and health considerations. Resources generally comprise links to web sites, but can also include videos, seminars, newsletters, articles, and the like. The resources include information on various medical conditions, lifestyle issues, and other subject matter that can impact health. Of particular usefulness is the fact that the resources are specifically selected not only based on the users conditions, but also on the reliability of the information. The internet (for example) is full of information; however, the reliability of the information is often questionable and difficult for a layperson to evaluate. Individuals often find it difficult to discern the difference between trustworthy information, and illegitimate or harmful information. The resources have been internally vetted to ensure that only reliable sources of information are made available.

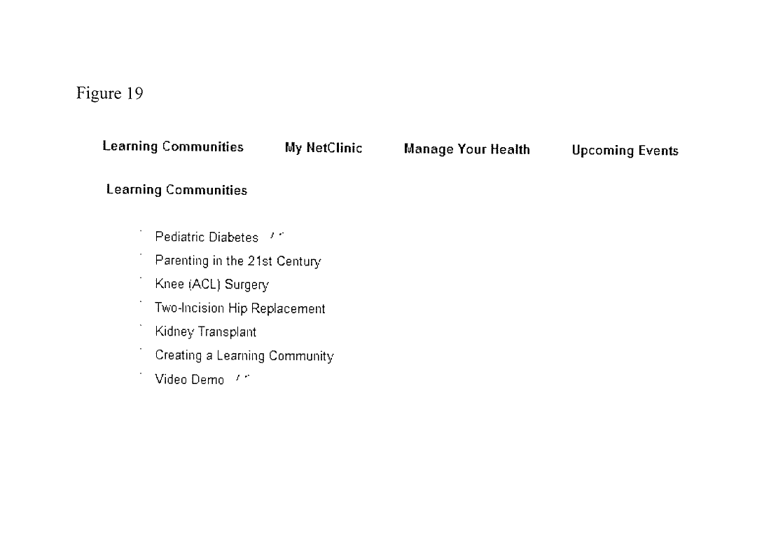

FIG. 19 shows the initial Learning Communities page, which is accessed by selecting the Learning Communities area or drop down menu from the application home page. The page shows the available learning communities and the user can select the most applicable communities. Alternatively, the learning communities displayed are those that are most applicable based on the information entered into the application by the user.

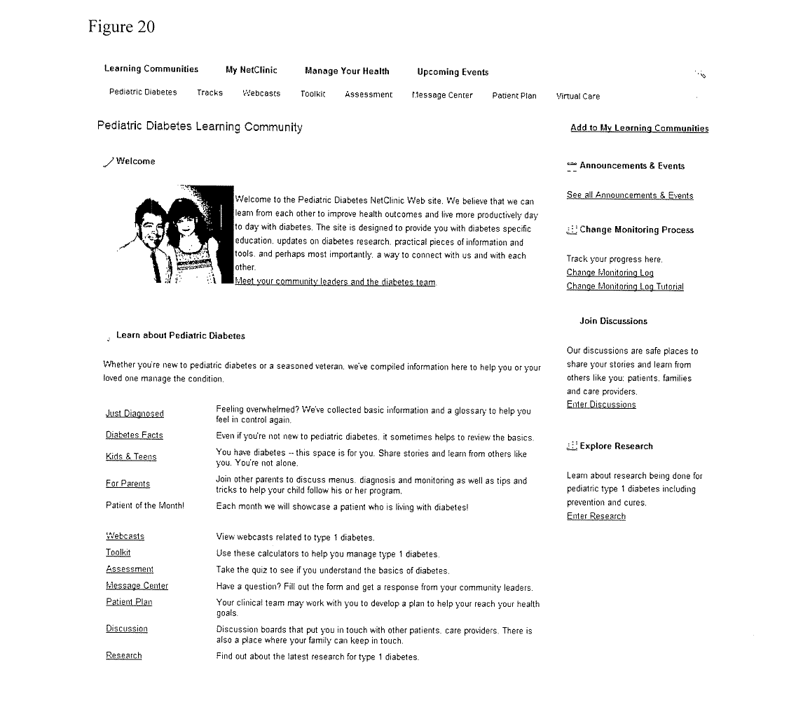

FIG. 20 shows a typical learning community page, and in particular, the Juvenile Diabetes learning community page. While the features of learning communities are described in reference to a certain example, the features are generally applicable to any learning community.

The learning community comprises generally one or more tracks, which include content-based divisions of information within the communities. In the case of the Juvenile Diabetes learning community, the tracks include Just Diagnosed, Diabetes Fact, Kids & Teens, and For Parents tracks. Each learning community track has information tailored to the specific track. The information is accessed by selecting the particular track of interest.

The learning communities include several additional features generally classified under the Other Resources heading. These include: webcasts for access to online educational classes and forums; tool kits described in detail herein-below; assessments which provides a means for the user and a specific health care professional to assess the user's level of experience and education with their health care needs and conditions, which is useful in developing a treatment plan, the assessment can be as simple as a test/quiz or an interactive session with a health care provider; discussion, which provides one or more social media options to allow the users to interact with other users in a similar position, the options include forums, message boards, and the like for posting or presenting information (the discussion page can also be reached from the Join Discussion link); a message center where users can exchange messages with a health care provider; and research which provides links to information of interest based on user specific information as well as the particular learning community, this information is selected based not only on relevance but also on credibility and quality factors (this prevents the user from having to vet information themselves and/or fall prey to unreliable and inaccurate information widely available on the internet).

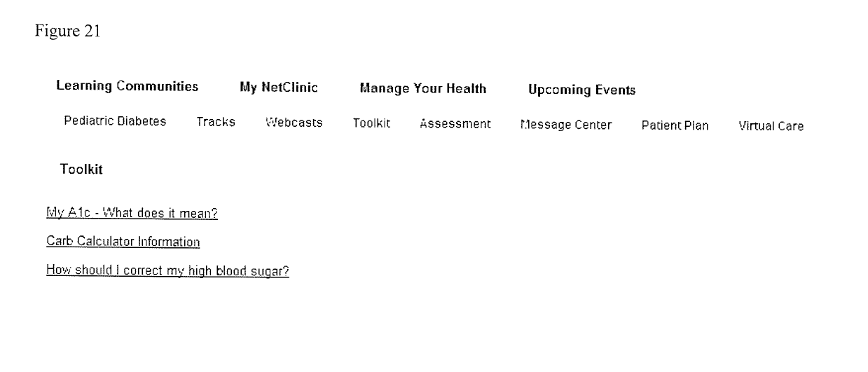

FIG. 21 shows the toolkit page. The toolkit provides the tools to allow a user to track and monitor conditions or calculate important information relating to their health. In the case of the pediatric diabetes, the toolkit allows a user to interactively provide information relating to blood sugar levels, how to correct levels, and information relating to diet considerations.

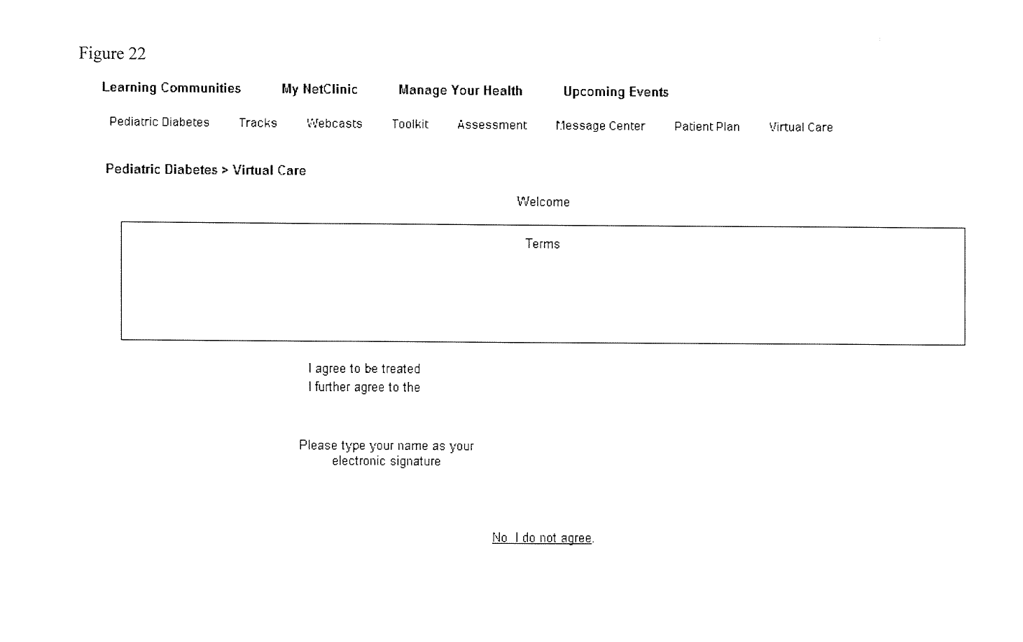

FIG. 22 shows the virtual care page. This page initiates a virtual video link between the user and the user's selected health care professional for purposes of treatment, assessment, or evaluation. In this particular case, a consent page appears, but once consent is obtained (or if consent is not required) a screen appears that asks the user to select the desired health care professional from a list of available professionals, and then a video link is established to allow for real time interactive communication between the user and the professional. The available health care professionals are selected based on the information input into the application by the user and the particular learning community selected. For example, the user can select a particular clinic where they have a relationship with health care professionals, and the list of available professionals will include those with expertise in conditions relevant to the user's needs. Additionally, the virtual link includes the capacity to access live (via video and audio) language interpreters to work with users, or users family members, that do not speak English, or otherwise when there is a need for translation.

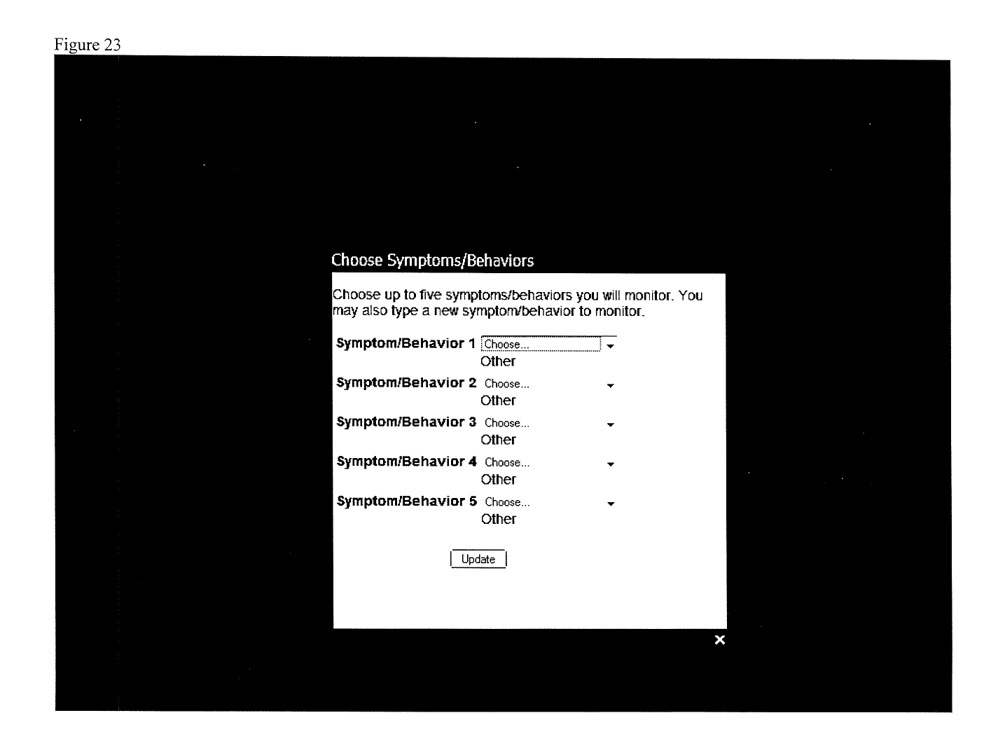

FIG. 23 shows the monitoring log page. This page can be accessed by selecting the change monitoring log link on the learning communities page shown in FIG. 20. The page allows the user to setup a schedule for monitoring and recording information relevant to the user's care plan and medical conditions, which are then shared with the user's health care professional as part of the users overall care plan protocol. The page initially, as shown in FIG. 21, requests that the user select one or more parameters to monitor that their health coach or clinician has requested per their care plan. The parameters are selected from one of drop down menus. Examples of monitoring parameters include glucose levels, appetite, blood pressure, heart rate, weight, and the like.

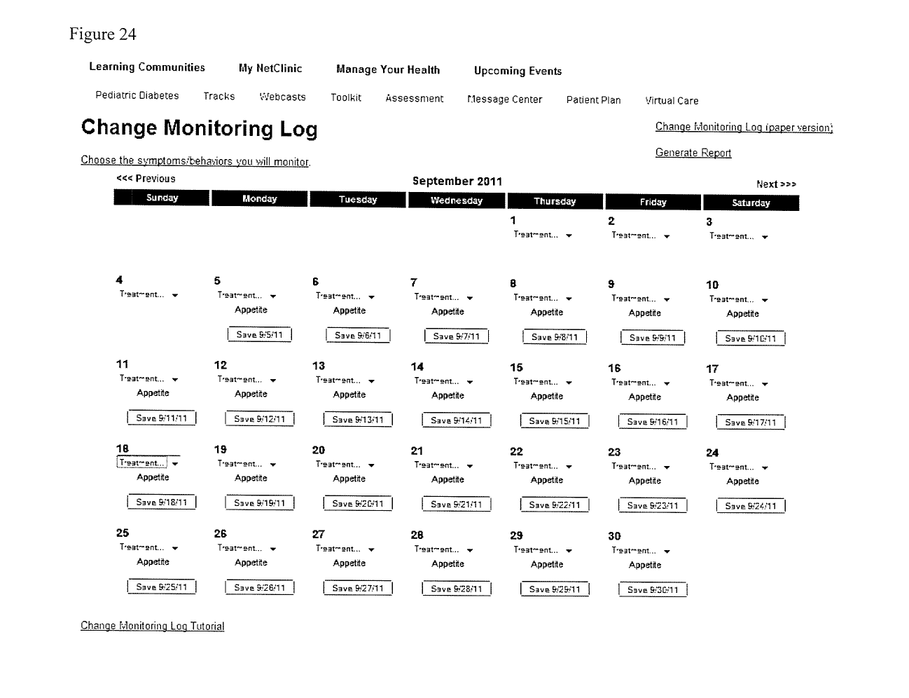

FIG. 24 shows the monitoring log calendar after the monitoring parameters have been selected. The calendar provides the patient user with the ability to assign monitoring parameters by specific days, whereby the information is entered and on the assigned day. The information is shared with the user's health care professional thereby enhancing compliance and treatment. The monitoring log function also includes the ability to create paper logs, and as well as generating reports of logging activity.

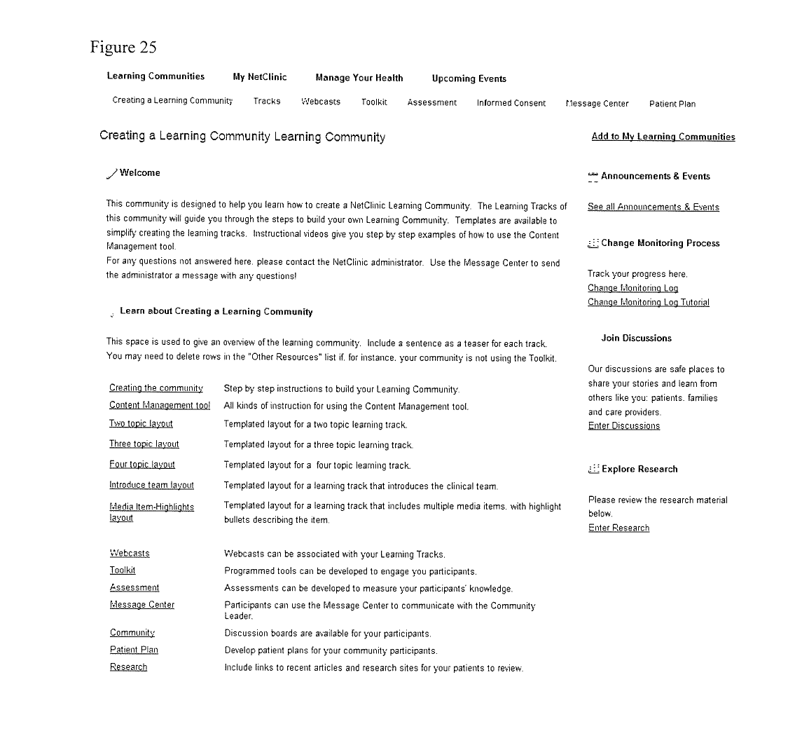

FIG. 25 shows the create learning community template page. This page includes all the functionality to allow a learning community leader user to easily create, edit, and maintain their own learning communities, which can be accessed by patient users of the application. The page includes templates for creating custom tracks as well as providing for additional resources.

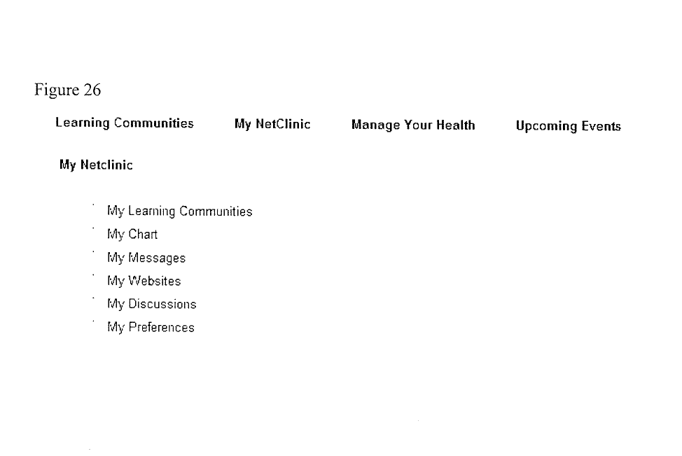

FIG. 26 shows the My NetClinic home page, which is an area that allows the user to customize the application based on their individual needs and interests. The My NetClinic area provides the ability for the user to perform one or more of the following: to link directly to personal learning communities created by the learning community leader user or those that the learning community leader user identifies as relevant to their specific conditions; to link to the user's medical chart to allow for direct real time review of the information entered into the chart by the user's health care professionals; to link to messages left for, or to, the user's health care professional; to link to websites entered by the user, for example, to a personal webpage maintained by the user; to link to the users discussion pages, forums, social media pages and postings; and a link to the users preferences which allows the user to change their profiles settings and the like.

In the foregoing manner, the present invention substantially eliminates the problems of the prior art. In particular, the present invention is believed to have a substantial positive impact on user/patient compliance. It has been well demonstrated that better health care outcomes than are presently experienced are possible if users/patients were willing to take a more proactive and focused position with regard to their health care decisions through screening tests, better lifestyle choices when it comes to diet, exercise, alcohol and tobacco consumption, as well as other factors. A huge number of health care problems can be avoided or reduced through better compliance. However, users/patients do not tend to follow advice especially if it comes from sources such as insurance providers, and/or employers that administer health care plans. Users/patients often view these sources of information as biased toward reducing administrative or insurance costs at the expense of providing treatment.

This is generally not the case if the user receives advice from their care professionals, whose advice is much more likely to be viewed as unbiased and taken seriously. The present invention, by creating an efficient direct dialogue between the user and the health care professional can more efficiently influence behavior, enhance compliance, and ultimately provide better care at a lower cost.

Thus, the present invention activates the user/patient toward better health care by providing better information, access to health care professionals, and compliance goals and feedback. In other words, one of the most important barriers to improving users' health and lowering health care costs is changing a user's behavior in a positive manner. Corporations, health insurance companies, physicians, health coaches and pharmaceutical companies have all actively searched for ways to increase patient activation, the term often used to describe patient behavior change, i.e. taking their medication, losing weight, getting their health screening completed, making better lifestyle decisions.

The present invention utilizes the power of social media, video-based interactions, information access, and coordination to drive additional and more effective patient activation through increased patient engagement with their heath care professionals. It also allows health systems to appropriately engage patients to standardize expectations. For example, in today's system there is tremendous overuse of x-rays and CAT scans in patients with uncomplicated back pain. Patients often arrive thinking that these images provide additional value. In this system when a patient engages with an episode of back pain the system automatically assigns media materials pertinent to the condition that convey the evidence in simple and understandable terms which explain that scans increase cost and radiation exposure with no demonstrable clinical benefit. This education can be produced by their clinicians or accessed from other sources. Patients trust and will listen to their health care professionals about their health more than any other source. Health insurance companies have failed miserably in their disease management efforts to connect directly with their members because consumers do not trust their advice to be in their best interest. Corporations have tried to focus on increasing incentives to lose weight, stop smoking, exercise, etc. with minimal effects.

However, there is a shortage of primary care physicians in the US and patients are increasingly putting off seeing their doctor to save money, as more and more consumers are responsible for the cost of the care through their employer benefits plan with higher co-pays and higher deductible plans increasing in popularity with employers.

The present invention uses a computer implemented interface and information collection system to help health care professionals proactively engage with their patients, identifying high risk patients and providing them with proactive, evidence-based care management, care coordination and easy access to their care team utilizing internet-based applications to increase efficiency and maximize the valuable physician resource base.

The present invention utilizes interactive network connections, and multi-media communication applications, to communicate more effectively with patients. Patients learn about their specific risk factors (based upon their family and personal health history), learn more about their disease/condition, treatment options, collaborate on their care plans and connect with members of the online care team, such as primary care, nurse educators, health coaches, pharmacists and specialists, and gives patients a way to connect with other patients facing a similar diagnosis.

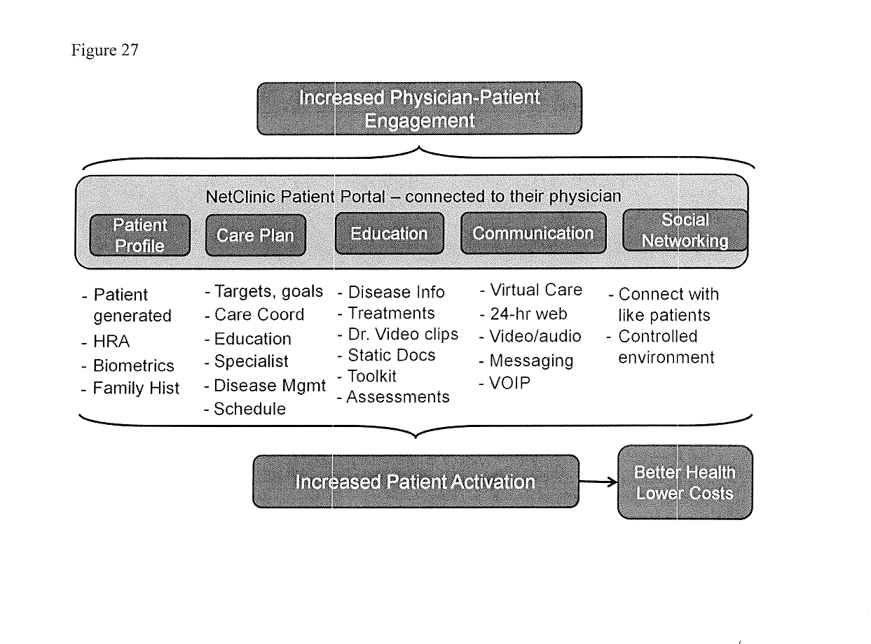

FIG. 27 summarized the features of the present invention that are used to accomplish the foregoing that will lead to increased patient activation.

The present invention utilizes the unique health integration coding system to configure a personal identification number (ID) that defines how the fundamental elements of the system need to interrelate to decrease the complexity of access to services and health care payment component. The administrative functions allow ongoing reporting and management of access interfaces, service models, and business models.

While the preferred embodiment of the invention has been described in reference to the Figures, the invention is not so limited.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A computerized method for administration of a health care system, said method comprising:
providing a computer system having remote access capability to one or more participants via a remote computer link;
assessing the participants health care needs through one or more query instructions utilizing said computer system to collect the participants health care information; and
aggregating the health care information into a unique participant ID.

2. The method of claim 1 wherein said ID encodes information about said participant's personal health history.

3. The method of claim 1 wherein said ID encodes information about said participant's health plan.

4. The method of claim 1 wherein said ID encodes information about said participant's provider group.

5. The method of claim 4 wherein said ID encodes information about said participant's provider group location.

6. The method of claim 4 wherein said ID encodes information about said participant's provider group specialty.

7. The method of claim 1 wherein said ID encodes information about said participant's personal health condition.

8. The method of claim 1 wherein said ID encodes participant's health, demographic, health plan product, and provider network configuration information without reference to participant's health records or other health information.

9. The method of claim 8 wherein said assessment includes a personal profile.

10. The method of claim 8 wherein said assessment includes a personal health history.

11. The method of claim 8 wherein said assessment includes health habits.

12. The method of claim 8 wherein said assessment includes family history.

13. The method of claim 8 further comprising learning communities that provide vetted health information.

14. The method of claim 8 further comprising symptom and behavior tracking tools.

15. The method of claim further comprising a monitoring log tool.
